(19) United States
(12) Patent Application Publication
(10) Pub. No.: US 2026/0118877 A1
(43) Pub. Date: Apr. 30, 2026

(54) UNMANNED MOVING OBJECT POSITIONING CORRECTION SYSTEM USING DISTANCE DETECTION SENSOR, AND METHOD THEREFOR

(71) Applicant: SEOROBOTICS CO., LTD., Anyang-si, Gyeonggi-do (KR)

(72) Inventors: Seung Gi LEE, Uiwang-si, Gyeonggi-do (KR); Jae Ik SHIM, Seoul (KR)

(21) Appl. No.: 19/478,813

(22) PCT Filed: Nov. 21, 2024
(86) PCT No.: PCT/KR2024/018460

§ 371 Date: Oct. 25, 2025

(30) Foreign Application Priority Data
Nov. 30, 2023 (KR) 10-2023-0171228

(51) Int. Cl. G05D 1/246; G06T 7/50; G06T 7/70

(52) U.S. Cl. CPC G05D 1/246; G06T 7/50; G06T 7/70; G06T 2207/30252

(57) ABSTRACT

Provided is a positioning correction system for an unmanned mobile body using a distance detection sensor and a positioning correction method for an unmanned mobile body using the system. More particularly, the positioning correction system includes a distance detector for detecting a distance to surrounding objects during travel of an unmanned mobile body, and transmitting detected detection data; a driving manager for receiving the detection data to perform positioning of the unmanned mobile body, analyzing an accuracy of the positioning information to determine whether to correct the positioning information, and generating and transmitting a driving control signal for the unmanned mobile body; and an unmanned mobile body manager for receiving the detection data from the distance detector and transmitting the received detection data to the driving manager, receiving the driving control signal from the driving manager to control driving of the unmanned mobile body, etc.

### TECHNICAL FIELD

The present invention relates to a positioning correction system and method for an unmanned mobile body using a distance detection sensor that can improve the accuracy of positioning for an unmanned mobile body that performs localization via camera-based Simultaneous Localization And Mapping (SLAM).

### BACKGROUND ART

Generally, in an unmanned mobile body including a mobile robot, an angular velocity sensor that detects changes in the driving direction is prone to significant output errors due to environmental changes such as ambient temperature or vibration. In such cases, the output error of the angular velocity sensor needs to be corrected using an absolute position display device or a geomagnetic direction sensor, which leads to problems of a complex configuration and a long time required for the correction work.

Accordingly, for the safe movement of an unmanned mobile body, various methods have been developed for calculating the positioning of the unmanned mobile body using lidar.

However, in the case of methods for calculating the positioning of an unmanned mobile body using lidar, there are problems in that lidar is very expensive and vulnerable to external obstacles such as smoke, and its short lifespan inevitably increases maintenance costs.

Meanwhile, for some unmanned mobile bodies, there was a problem in that the situations in which positioning can be calculated based on lidar are limited.

In addition, in the case of the method of calculating the positioning of an unmanned mobile body using a camera, it has the problem of lower accuracy while it has the advantages of lower maintenance costs and a longer lifespan than lidar.

The background art or related art described herein is provided only to aid in understanding the technical significance of the present invention and is not intended to imply that it was technology widely known in the technical field to which the present invention pertains prior to the filing of the application for the present invention.

### RELATED ART DOCUMENTS

### Patent Documents

(Patent Document 1) Korean Patent Application Publication No. 10-2023-0128683

### DISCLOSURE

### Technical Problem

Therefore, the present invention has been made in view of the above problems, and it is one object of the present invention to provide a positioning correction system and method for an unmanned mobile body using a distance detection sensor that can improve the accuracy of positioning for an unmanned mobile body that performs positioning via SLAM.

It is another object of the present invention to provide a positioning correction system and method for an unmanned mobile body using a distance detection sensor that can reduce the cost of the positioning system for the unmanned mobile body by using the distance detection sensor instead of an expensive rotary lidar and improve the accuracy of positioning via the distance detection sensor.

It is still another object of the present invention to provide a positioning correction system and method for an unmanned mobile body using a distance detection sensor that is capable of long-term use by acquiring data for positioning only when performing positioning, thereby extending the lifespan of the distance detection sensor.

It is yet another object of the present invention to provide a positioning correction system and method for an unmanned mobile body using a distance detection sensor that can prevent errors, such as delays or arbitrary cancellations of tasks to be performed by the unmanned mobile body, by assigning priority to positioning according to the importance of the work schedule.

However, the objects of the present invention are not limited to the foregoing, and it is to be understood that objects or effects that can be appreciated from the means for solving the problem or the embodiments, even if not explicitly mentioned, are also included herein.

### Technical Solution

In accordance with an aspect of the present invention, the above and other objects can be accomplished by the provision of a positioning correction system for an unmanned mobile body, the positioning correction system including: a distance detector for detecting a distance to surrounding objects during travel of an unmanned mobile body, and transmitting detected detection data; a driving manager for receiving the detection data to perform positioning of the unmanned mobile body, analyzing an accuracy of the positioning information to determine whether to correct the positioning information, and generating and transmitting a driving control signal for the unmanned mobile body; and an unmanned mobile body manager for receiving the detection data from the distance detector and transmitting the received detection data to the driving manager, receiving the driving control signal from the driving manager to control driving of the unmanned mobile body, generating work schedule information for the unmanned mobile body, and comparing the generated work schedule information with the driving control signal to control driving of the unmanned mobile body based on an information piece or signal with a higher priority.

In an embodiment, the driving manager may include: a positioning and mapping part for generating positioning information and new map information of the unmanned mobile body based on Simultaneous Localization And Mapping (SLAM) on a basis of the detection data transmitted from the unmanned mobile body manager; a driving controller for analyzing accuracy of the positioning information and the new map information, and generating and transmitting a position correction control signal for position correction of the unmanned mobile body; a driving command generator for receiving the position correction control signal, generating a driving control signal for the unmanned mobile body corresponding to the position correction control signal and transmitting the generated driving control signal to the unmanned mobile body manager; a database in which data generated via the distance detector, the driving manager, and the unmanned mobile body manager is stored; and an abnormal data remover for processing abnormal data from the data stored in the database.

In an embodiment, the driving controller may be configured to generate the position correction control signal and transmit it to the driving command generator when a threshold value of SLAM quality of the positioning information is lower than a set SLAM real value.

In an embodiment, the driving controller may be configured to receive quality threshold value information for the detection data from the unmanned mobile body manager, and to generate the position correction control signal and transmit it to the driving command generator only when the received quality threshold value information is lower than a set SLAM real value.

In an embodiment, when transmitting the driving control signal for the position correction control signal to the unmanned mobile body manager, the driving command generator may be configured to generate priority information for the driving control signal and transmit it together with the driving control signal.

In an embodiment, the unmanned mobile body manager may include: a data acquisitor for receiving the detection data detected by the distance detector and transmitting the received detection data to the driving manager; a driving controller for correcting a position of the unmanned mobile body when the driving control signal is received from the driving manager; and a schedule manager for comparing the work schedule information of the unmanned mobile body with the priority information of the driving control signal to generate driving priority list information for the unmanned mobile body, and sharing the driving priority list information with the driving controller.

In an embodiment, the data acquisitor may be configured to periodically generate quality threshold value information for the detection data at predetermined time intervals and transmit the generated quality threshold value information to the driving manager.

In an embodiment, when the driving control signal is received, the driving controller may be configured to check an importance of task information for a task currently being performed by the unmanned mobile body, and, when a priority of the currently performed task is higher than a position correction task for the unmanned mobile body as a result of the check, to control the position correction to be performed after the currently performed task is completed.

In an embodiment, the distance detector may be configured as a single-channel sensor module or a multi-channel sensor module including at least two or more sensors.

In accordance with another aspect of the present invention, there is provided a positioning correction method using a positioning correction system for an unmanned mobile body, the method including the steps of: (a) acquiring, via a distance detector, detection data including distance information and image information between an unmanned mobile body and an object; (b) generating, by a positioning and mapping part of a driving manager, positioning information and new map information of the unmanned mobile body based on Simultaneous Localization And Mapping (SLAM) on a basis of the detection data; (c) analyzing, by a driving controller of the driving manager, the positioning information and new map information to generate a position correction control signal for the unmanned mobile body, and transmitting the generated position correction control signal to a driving command generator; (d) generating, by the driving command generator that received the position correction control signal, a driving control signal for the unmanned mobile body and transmitting the driving control signal to a driving controller of an unmanned mobile body manager; and (e) correcting a position of the unmanned mobile body according to a control of the driving controller.

In another embodiment, in the step (c), the position correction control signal may be generated only when a threshold value of SLAM quality of the positioning information is lower than a set SLAM real value.

In another embodiment, the step (e) may include: (e1) checking whether working devices are in operation; (e2) if the working devices are in an operational state, checking task priority information for work schedule information generated by a schedule manager; (e3) if the task priority information of the working devices is higher than priority information of the driving control signal, controlling currently performed task to continue, and if the task priority information is lower than the priority information of the driving control signal, interrupting the currently performed task; and (e4) when the interruption of the task is completed, controlling a driving means to correct the position of the unmanned mobile body.

In another embodiment, the method may further include, after the step (e): (f) a data refining step of analyzing data stored in a database of the driving manager to identify the presence of abnormal data, and processing the abnormal data if it exists.

In addition to the technical problems of the present invention mentioned above, other features and advantages of the present invention will be described hereinafter, or will be clearly understood by those of ordinary skill in the art to which the present invention pertains from such description and explanation.

### Advantageous Effects

The present invention as described above provides the following effects.

A positioning correction system and method for an unmanned mobile body using a distance detection sensor according to the present invention can improve the accuracy of positioning for an unmanned mobile body that performs positioning via SLAM.

The positioning correction system and method for an unmanned mobile body using the distance detection sensor according to the present invention can reduce the cost of the positioning system for the unmanned mobile body by using the distance detection sensor instead of an expensive rotary lidar and improve the accuracy of positioning via the distance detection sensor.

The positioning correction system and method for an unmanned mobile body using the distance detection sensor according to the present invention are capable of long-term use by acquiring data for positioning only when performing positioning, thereby extending the lifespan of the distance detection sensor.

The positioning correction system and method for an unmanned mobile body using the distance detection sensor according to the present invention can prevent errors, such as delays or arbitrary cancellations of tasks to be performed by the unmanned mobile body, by assigning priority to positioning according to the importance of the work schedule.

Furthermore, the various and beneficial advantages and effects of the present invention are not limited to the foregoing, and will be more readily understood in the course of describing the specific embodiments of the present invention.

### DESCRIPTION OF DRAWINGS

FIG. 1 schematically illustrates an unmanned mobile body equipped with a positioning correction system using a distance detection sensor according to an embodiment of the present invention.

FIGS. 2 to 4 schematically illustrate a coupled state between a distance detector including a distance detection sensor according to an embodiment of the present invention and an unmanned mobile body.

FIGS. 5 to 7 schematically illustrate a state of acquiring positioning information through the positioning correction system for an unmanned mobile body according to an embodiment of the present invention.

FIG. 8 is a block diagram illustrating the positioning correction system for an unmanned mobile body according to an embodiment of the present invention.

FIGS. 9 and 10 are flowcharts illustrating a positioning process of an unmanned mobile body using the positioning correction system for an unmanned mobile body according to an embodiment of the present invention.

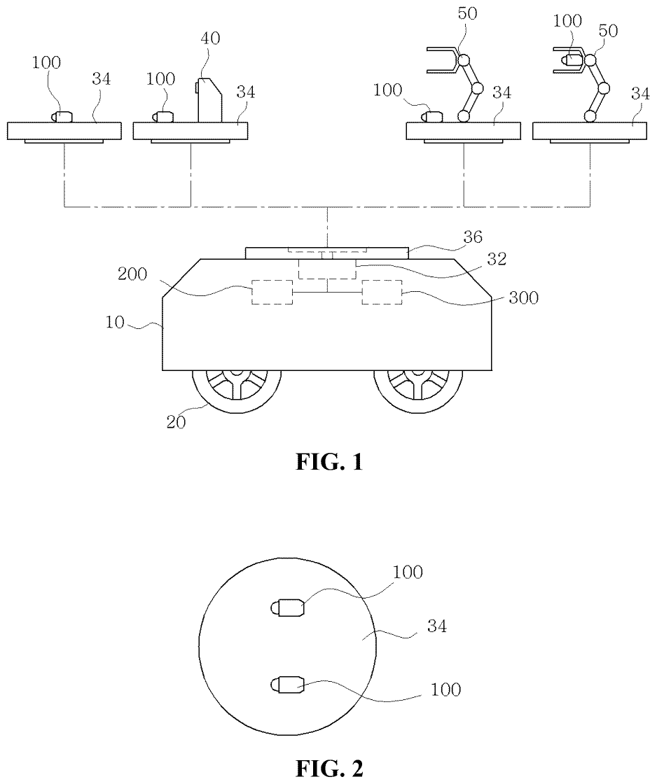

### BEST MODE

Hereinafter, preferred embodiments of the present invention will be described in detail with reference to the accompanying drawings. It is to be noted that in assigning reference numerals to the components of the drawings, the same components are designated by the same reference numerals as far as possible even when they are shown in different drawings.

In addition, in describing the present invention, it should be noted that the technical terms used are merely for the purpose of describing particular embodiments and are not intended to limit the scope of the present invention. Furthermore, when it is determined that a detailed description of a related known configuration or function may obscure the subject matter of the present invention, such a detailed description will be omitted. In addition, in describing the present invention, general terms should be interpreted based on their predefined definitions or the context, and should not be construed in an overly restrictive sense. If a technical term used is an incorrect term that fails to accurately represent the technical idea of the present invention, it should be understood by being replaced with a technical term that a person of ordinary skill in the art can properly understand.

In addition, in describing the present invention, terms such as “comprise,” “constitute,” or “have” are intended to indicate that a corresponding component may be inherent, unless explicitly stated otherwise. These terms should not be interpreted as necessarily including all of a plurality of components or steps, and it should be understood that some of the components or steps may not be included, or additional components or steps may be further included. All terms, including technical or scientific terms, have the same meaning as commonly understood by one of ordinary skill in the art to which this invention belongs, unless otherwise defined.

In addition, in describing the components of the present invention, identifiers such as first, second, A, B, (a), (b), etc., may be used. These identifiers are used to distinguish one component from another for the convenience of description only, and do not limit the essence, turn, or order of the corresponding component.

Further, the suffixes “module” and “unit” for components used in this specification are assigned or used interchangeably solely for the ease of drafting the specification, and do not in themselves have mutually distinct meanings or roles.

In addition, in the present invention, some of operations or functions described as being performed by a terminal, apparatus, or device may be performed instead by a server connected to the corresponding terminal, apparatus, or device. Likewise, some of the operations or functions described as being performed by a server may also be performed by a terminal, apparatus, or device connected to the corresponding server.

In addition, in the present invention, a terminal, apparatus, or device may refer not only to mobile devices such as a smartphone, a tablet PC, a wearable device, and a Head Mounted Display (HMD), but also to PC, a fixed terminal, apparatus, or device equipped with a display function, or devices capable of running applications, and is not limited to a specific type.

[Description of Symbols]

| | |
|---|---|
| 10: unmanned mobile body | 20: travel means |
| 30: driving means | 32: motor |
| 34: driving frame | 36: rotation support frame |
| 40: camera | 50: manipulator |
| 100: distance detector | 200: driving manager |
| 210: positioning and mapping part | 220: abnormal data remover |
| 230: driving controller | 240: driving command generator |
| 250: database | 300: unmanned mobile body manager |
| 310: data acquisitor | 320: driving controller |
| 330: schedule manager | |

### MODE FOR CARRYING OUT THE INVENTION

Hereinafter, embodiments of the present invention will be described in detail with reference to the accompanying drawings.

As shown in the drawings, a positioning correction system for an unmanned mobile body using a distance detection sensor of the present invention includes a distance detector 100 provided in a driving means 30 of an unmanned mobile body 10 and configured to detect a distance to surrounding objects when the unmanned mobile body is in motion and transmit the detected distance information to an unmanned mobile body manager 300; a driving manager 200 configured to receive data transmitted from the unmanned mobile body manager 300 to perform positioning and mapping of the unmanned mobile body 10, analyze the accuracy of the positioning information to determine whether to correct the positioning information, generate a driving control signal for the driving means 30 and transmit the generated driving control signal to the unmanned mobile body manager 300; and the unmanned mobile body manager 300 configured to transmit the distance information received from the distance detector 100 to the driving manager 200, receive a driving control signal from the driving manager 200 to control the driving of the driving means 30, generate work schedule information of the unmanned mobile body and transmit the generated work schedule information to the driving manager 200.

Here, the unmanned mobile body 10 may include a flying type, a ship type, or an underwater type unmanned mobile body 10. The unmanned mobile body 10 includes a travel means 20 for moving the unmanned mobile body 10 and the driving means 30 for driving the travel means 20, wherein the driving manager 200 and the unmanned mobile body manager 300 may be built-in.

In addition, the travel means 20 of the unmanned mobile body 10 may be configured with a general robot travel structure for the rotational operation of a wheel, the operation of an N-legged multi-jointed robot arm, and the rolling operation of a track, and the driving means 30 may be configured to include a general motor 32, a driving frame 34 that is rotationally operated by the motor 32, and a rotation support frame 36 that supports the rotational operation of the driving frame 34.

Meanwhile, either a camera module 40 or a manipulator 50, or both may be mounted on the driving frame 34 of the unmanned mobile body 10 of the present invention.

The distance detector 100 is configured in the driving means 30 of the unmanned mobile body 10, and is preferably coupled to the driving frame 34 of the driving means 30 to detect the distance between the unmanned mobile body 10 and an object including a wall or an item in an indoor space, generate distance information, and transmit the generated distance information to the unmanned mobile body manager 300.

The distance detector 100 may be configured as a single-channel sensor module, which consists of a single detection means for detecting the distance between the unmanned mobile body 10 and an object, or as a multi-channel sensor module, which consists of at least two or more detection means.

The distance detector 100 of the present invention may include a sensor capable of acquiring distance data, such as a PSD sensor, a TOF sensor, an ultrasonic sensor, a fixed lidar sensor, a vision camera, and a depth camera.

In addition, when the driving means 30 is driven by a driving controller 320 to be described later, the distance detector 100 of the present invention may detect the distance between the unmanned mobile body 10 and an object including a wall or an item in an indoor space, generate distance information, and transmit the generated distance information to a data acquisitor 310 of the unmanned mobile body manager 300.

In addition, the distance detector 100 of the present invention may collect image information about the indoor space when the driving means 30 is driven, and may transmit the collected image information to the data acquisitor 310.

As shown in FIG. 2, at least one distance detector 100 may be configured on the driving frame 34.

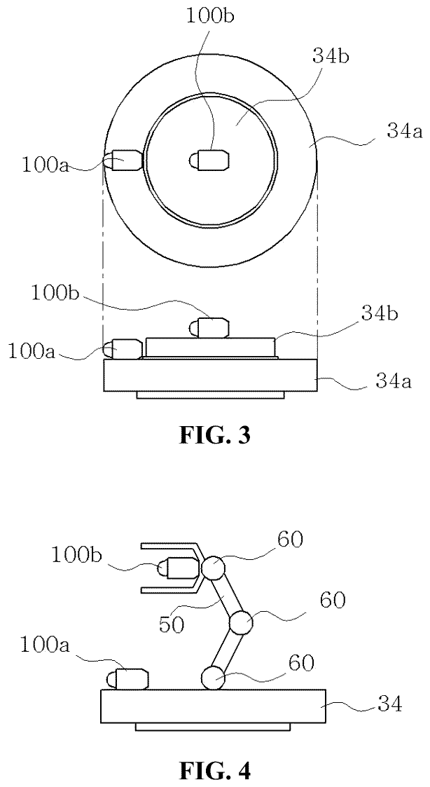

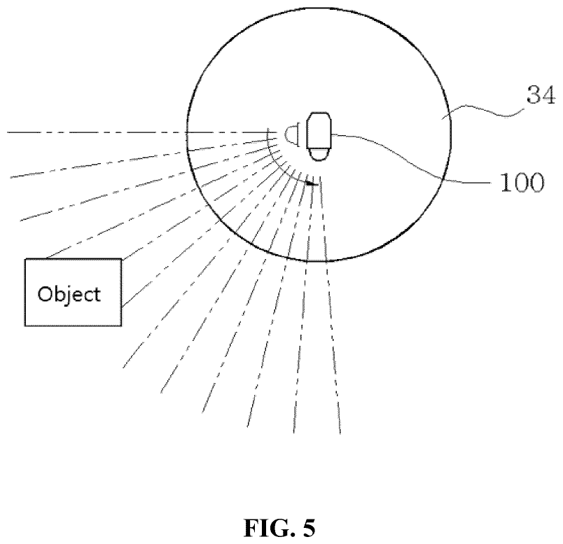

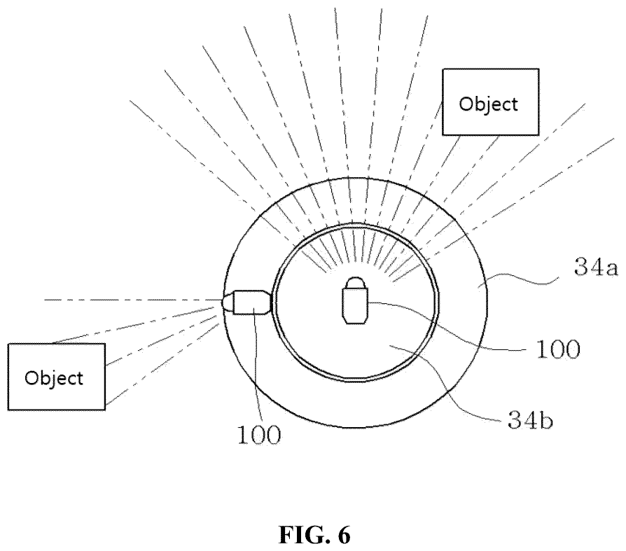

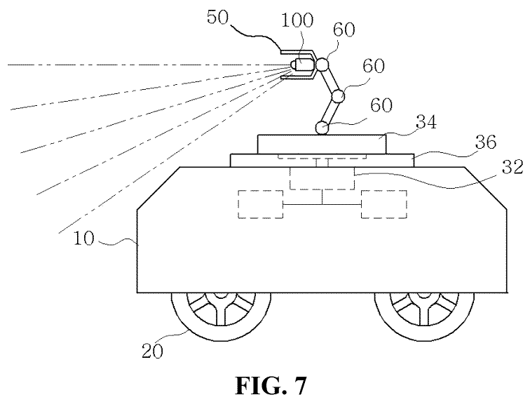

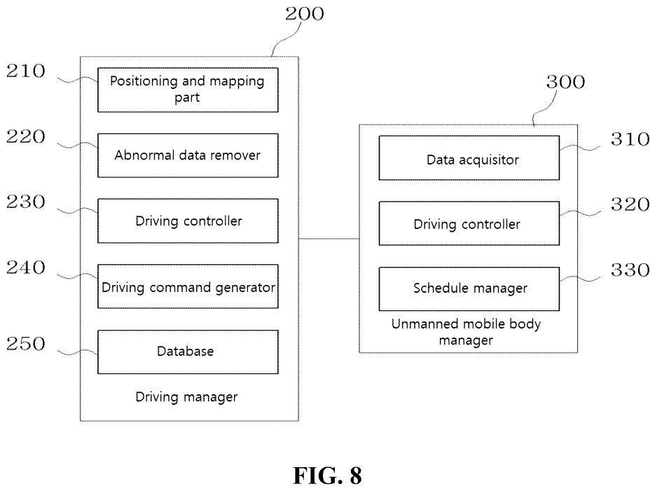

Meanwhile, as shown in FIG. 3, when the driving means 30 is configured with a plurality of independent motors 32, the driving frame 34 may correspondingly be configured with a first driving frame 34a and a second driving frame 34b. In this case, the second driving frame 34b may be configured on the first driving frame 34a.

Here, the distance detector 100 may be configured as first and second distance detectors 100a and 100b so that they can be respectively coupled to the first and second driving frames 34a and 34b, and when detecting an initial distance, the first and second distance detectors 100a and 100b may be configured to be positioned in the same direction or at the same angle.

Furthermore, as shown in FIG. 4, when the manipulator 50 is mounted on the driving frame 34, the distance detector 100 may be coupled to each of the driving frame 34 and the manipulator 50, or the distance detector 100 may be coupled only to the manipulator 50.

The driving manager 200 includes a positioning and mapping part 210, an abnormal data remover 220, a driving controller 230, a driving command generator 240 and a database 250.

The positioning and mapping part 210 operates based on Simultaneous Localization And Mapping (SLAM), and based on detection data including distance information and image information transmitted from the data acquisitor 310 of the unmanned mobile body manager 300, it performs positioning of the unmanned mobile body 10 and generates new real-time map information based on the current position of the unmanned mobile body 10.

In this process, when generating the new map information, the positioning and mapping part 210 may recognize an object to include it in the new map information, and may generate it as three-dimensional new map information.

Here, the positioning and mapping part 210 of the present invention performs positioning of the unmanned mobile body 10 via camera-based SLAM to generate positioning information, and transmits the generated positioning information to the database 250.

In addition, when performing positioning of the unmanned mobile body 10, the positioning and mapping part 210 generates current position information of the unmanned mobile body 10, generates new real-time map information based on the generated current position information, and then stores it in the database 250.

Preferably, the positioning and mapping part 210 recognizes the current position of the unmanned mobile body 10 in an indoor space and performs mapping based on the detection data from the recognized current position.

The abnormal data remover 220 analyzes the detection data, positioning information, and new map information stored in the database 250, and serves to process abnormal data containing outliers within this detection data, positioning information, and new map information.

Here, an outlier refers to a very small or large value that deviates significantly from the range of normally observed data. When analyzing or modeling data required for decision-making, such an outlier can significantly impact the decision. Therefore, by performing appropriate outlier processing during the data preprocessing stage, the reliability of the data may be improved.

When the distribution of the detection data, positioning information, and new map information is a normal distribution, the abnormal data remover 220 may process the abnormal data contained therein through the Standard Deviation technique that detects outliers using the standard deviation of the data.

However, the present invention is not limited thereto, and when the distribution of the detection data, positioning information, and new map information is not a normal distribution or is skewed to one side, the processing may also be performed by either the Interquartile Range (IQR) technique, which detects outliers using the IQR value of detection data, positioning information, and new map information, or the Density Based Spatial Clustering of Applications with Noise (DBScan) technique, which is a density-based clustering algorithm that detects as outliers any detection data, positioning information, and new map information not belonging to a cluster.

The driving controller 230 analyzes the accuracy of the positioning information stored in the database 250, and according to the accuracy of this positioning information, generates a control signal for position correction of the unmanned mobile body 10 and transmits it to the driving command generator 240.

The driving controller 230 may set a SLAM real value as a standard for SLAM quality, and if the threshold value of the SLAM quality of the positioning information is lower than the set SLAM real value, it generates a control signal for position correction of the unmanned mobile body 10 and transmits it to the driving command generator 240.

Meanwhile, the driving controller 230 may receive quality threshold value information for the distance information and image information contained in the detection data from the data acquisitor 310 of the unmanned mobile body manager 300. If this quality threshold value information is higher than the set SLAM real value, it may not generate a control signal for position correction of the unmanned mobile body 10, and may be configured such that the unmanned mobile body 10 continues to travel or perform tasks while continuously collecting and acquiring detection data.

The driving command generator 240 receives a position correction control signal from the driving controller 230, generates a distance value for the unmanned mobile body 10 to move and a driving control signal for the driving means 30 corresponding to this distance value, and transmits them to the driving controller 320 of the unmanned mobile body manager 300.

At this time, the driving command generator 240 may generate a driving control signal including a rotation angle value for the driving means 30 of the unmanned mobile body 10 and transmit it to the driving controller 320.

When transmitting the driving control signal for the position correction control signal to the driving controller 320, the driving command generator 240 may generate priority information for this driving control signal and transmit it together.

Here, the priority information for the driving control signal may be determined according to whether the position correction of the unmanned mobile body 10 is urgent, and a reference value for the urgency of the position correction may be set by a user.

The database 250 receives the detection data detected by the distance detector 100 from the data acquisitor 310 and stores it, and stores the positioning information and new map information generated by the positioning and mapping part 210.

In the database 250, the detection data from which abnormal data has been removed by the abnormal data remover 220 may be stored independently. It also receives and stores schedule information of the unmanned mobile body 10, including task information, from a schedule manager 330, and stores basic map information about a space or area where the autonomous driving of the unmanned mobile body 10 will take place.

The unmanned mobile body manager 300 is connected to distance detector 100 and the driving manager 200 via a network, and is configured to transmit detection data from the distance detector 100 to the driving manager 200, and receive a driving control signal and a position correction control signal from the driving manager 200 to drive the unmanned mobile body 10, and includes the data acquisitor 310, the driving controller 320, and the schedule manager 330.

The data acquisitor 310 receives the detection data detected by the distance detector 310, and is configured to transmit the received detection data to the driving manager 200, particularly to the database 250 of the driving manager 200, to be stored.

In this case, when the data acquisitor 310 transmits the detection data to the database 250, it may be configured to simultaneously transmit the data to the positioning and mapping part 210, so that the positioning of the unmanned mobile body 10 and the generation of new map information are performed.

The data acquisitor 310 may generate quality threshold value information for the distance information and image information included in the detection data, and is preferably configured to periodically generate this information at certain time intervals and transmit it to the driving controller 230, thereby allowing for the periodic generation of a control signal for the position correction of the unmanned mobile body 10.

The driving controller 320 controls whether the unmanned mobile body 10 travels, by controlling whether to drive the driving means 30 included in the unmanned mobile body 10, particularly the motor 32 configured in this driving means 30.

Based on the basic map information stored in the database 250, the driving controller 320 controls whether to perform rotational operation for the autonomous driving of the unmanned mobile body 10, and during rotational operation, it may calculate the rotation angle value of the unmanned mobile body 10 to generate route information for autonomous driving.

In addition, when a position correction control signal is received from the driving controller 230 of the driving manager 200, the driving controller 320 modifies the previously generated route information and controls the driving of the driving means 30 based on the modified route information.

When a driving control signal corresponding to the position correction control signal is received, the driving controller 320 controls whether to drive the unmanned mobile body 10 according to the task priority set by the schedule manager 330.

In other words, before performing a correction for the current position of the unmanned mobile body 10, the driving controller 320 determines the importance of the information for the task currently being performed by the unmanned mobile body 10, and based on the importance of the task information, decides whether to correct the position of the unmanned mobile body 10.

In this case, as a result of checking the importance of the information for the task being performed by the unmanned mobile body 10, the driving controller 320 is configured such that the position correction is performed after the current task is completed, if the priority of the current task is higher than the position correction task for the unmanned mobile body 10.

Furthermore, as a result of checking the importance of the task information for the task being performed by the unmanned mobile body 10, the driving controller 320 interrupts the current task, performs the position correction of the unmanned mobile body 10, and is then configured to allow the interrupted task to be resumed, if the priority of the current task is lower than the position correction task for the unmanned mobile body 10.

At this time, when interrupting the current task, the driving controller 320 checks whether the motor 32 of the driving means 30 is running, and if the motor 32 is running, it is preferable that the subsequent action is performed after the driving of the motor 32 has completely stopped.

The schedule manager 330 is configured to receive work schedule information (which includes task information to be performed by the unmanned mobile body 10 and the importance degree for the task information) and to receive priority information for a driving control signal from the driving command generator 240 of the driving manager 200, so that they can be stored in the database 250.

In addition, the schedule manager 330 compares the work schedule information with the priority information of the driving control signal to generate driving priority list information for the unmanned mobile body 10, and is configured to store the generated driving priority list information in the database 250 and to share it with the driving controller 320.

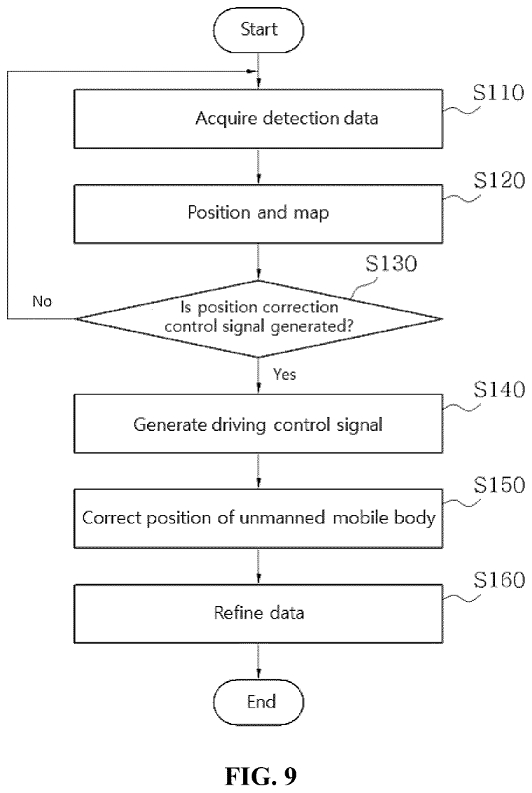

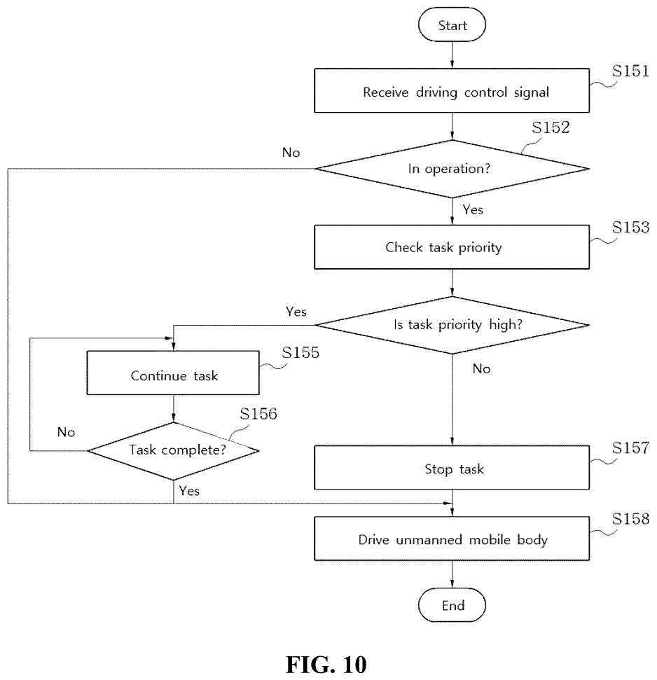

Hereinafter, the positioning correction method for an unmanned mobile body using the positioning correction system for an unmanned mobile body of the present invention will be described with reference to FIGS. 9 and 10.

The positioning correction method for an unmanned mobile body using the positioning correction system for an unmanned mobile body includes a step (S110) of driving the unmanned mobile body 10 when a travel command signal is received by the driving controller 320 of the unmanned mobile body manager 300.

Here, the step (S110) involves driving the driving means 30 of the unmanned mobile body 10 to perform autonomous driving based on the basic map information stored in the database 250, and simultaneously driving the distance detector 100 to acquire detection data including distance information and image information between the unmanned mobile body 10 and an object.

Next, when the detection data acquired via the distance detector 100 is received by the data acquisitor 310 of the unmanned mobile body manager 300, the data is transmitted to and stored in the database 250 of the driving manager 200, and positioning of the unmanned mobile body 10 is performed via the positioning and mapping part 210 and new real-time map information is generated based on the current position of the unmanned mobile body 10 (S120).

Next, the driving controller 230 analyzes the positioning information and new map information of the unmanned mobile body 10 generated via the positioning and mapping part 210, generates a control signal for position correction of the unmanned mobile body 10, and transmits the generated position correction control signal to the driving command generator 240 (S130).

At this time, if the threshold value of the SLAM quality of the positioning information is lower than the set SLAM real value, the driving controller 230 generates a control signal for the position correction of the unmanned mobile body 10 and transmits it to the driving command generator 240.

However, if the SLAM quality threshold value information is higher than the set SLAM real value, a control signal for the position correction of the unmanned mobile body 10 is not generated; instead, the unmanned mobile body 10 is allowed to continue traveling or performing tasks while detection data is continuously collected and acquired.

Next, the driving command generator 240 analyzes the received position correction control signal to generate a distance value for the unmanned mobile body 10 to move and a driving control signal for the driving means 30 corresponding to this distance value, and transmits the generated driving control signal to the driving controller 320 of the unmanned mobile body manager 300 (S140).

At this time, the driving control signal includes reference values, such as a rotation start angle, an end angle, a rotation resolution, a rotation speed, and a distance resolution, related to commonly used motor control for the motor 32 included in the driving means 30.

Next, the driving controller 320 of the unmanned mobile body manager 300 drives the driving means 30 based on the received driving control signal to correct the position of the unmanned mobile body (S150).

At this time, upon receiving a driving control signal (S151) as shown in FIG. 10, the driving controller 320 checks whether working devices, such as the camera 40 or the manipulator 50, which are connected to the driving means 30 of the unmanned mobile body 10, or the driving arm 60 for driving the camera 40 or the manipulator 50, are in operation (S152).

At this time, if it is determined that the task currently being performed is completed, or that the currently operating working devices are in a non-operational state, the driving controller 320 controls the driving of the driving means 30 for the position correction of the unmanned mobile body 10 based on the driving control signal.

However, the present invention is not limited to this; the driving controller may check the work schedule information for the next task to be performed by the unmanned mobile body 10, and, according to the priority information of this work schedule information, may either wait or control the driving means 30 for the position correction of the unmanned mobile body 10.

Furthermore, if the driving controller 320 determines that the working devices are currently in an operational state, it checks the task priority information for the work schedule information generated by the schedule manager 330. (153)

In the step (S153), the check for the task priority information corresponding to the work schedule information may be performed by using the driving priority list information generated by the schedule manager 330.

At this time, if the task priority information is higher than the priority information of the driving control signal, the currently performed task may be allowed to continue (S155), and when the corresponding task is completed, the driving means 30 may be controlled for the position correction of the unmanned mobile body 10 (S156).

However, if the task priority information is lower than the priority information of the driving control signal, the currently performed task is interrupted (S157).

Next, the driving means 30 is controlled to correct the position of the unmanned mobile body 10 (S158).

Meanwhile, the positioning correction method for an unmanned mobile body using the positioning correction system for an unmanned mobile body of the present invention further includes a data refining step of analyzing the data stored in the database 250 to identify the presence of abnormal data, and processing the abnormal data if it exists (S160).

The foregoing description is merely an exemplary illustration of the technical idea of the present invention, and it will be understood by one of ordinary skill in the art to which the present invention pertains that various modifications and variations are possible without departing from the essential characteristics of the present invention. Therefore, the embodiments disclosed in the present invention are intended not to limit the technical idea of the present invention but to describe it, and the scope of the technical idea of the present invention is not limited by these embodiments. The scope of protection of the present invention should be interpreted by the following claims, and all technical ideas within the equivalent scope should be construed as being included in the scope of the right of the present invention.

1. A positioning correction system for an unmanned mobile body, the positioning correction system comprising:
a distance detector for detecting a distance to surrounding objects during travel of an unmanned mobile body, and transmitting detected detection data;
a driving manager for receiving the detection data to perform positioning of the unmanned mobile body, analyzing an accuracy of the positioning information to determine whether to correct the positioning information, and generating and transmitting a driving control signal for the unmanned mobile body; and
an unmanned mobile body manager for receiving the detection data from the distance detector and transmitting the received detection data to the driving manager, receiving the driving control signal from the driving manager to control driving of the unmanned mobile body, generating work schedule information for the unmanned mobile body, and comparing the generated work schedule information with the driving control signal to control driving of the unmanned mobile body based on an information piece or signal with a higher priority.

2. The positioning correction system according to claim 1, wherein the driving manager comprises:
a positioning and mapping part for generating positioning information and new map information of the unmanned mobile body based on Simultaneous Localization And Mapping (SLAM) on a basis of the detection data transmitted from the unmanned mobile body manager;
a driving controller for analyzing accuracy of the positioning information and the new map information, and generating and transmitting a position correction control signal for position correction of the unmanned mobile body;
a driving command generator for receiving the position correction control signal, generating a driving control signal for the unmanned mobile body corresponding to the position correction control signal and transmitting the generated driving control signal to the unmanned mobile body manager;
a database in which data generated via the distance detector, the driving manager, and the unmanned mobile body manager is stored; and
an abnormal data remover for processing abnormal data from the data stored in the database.

3. The positioning correction system according to claim 2, wherein the driving controller is configured to generate the position correction control signal and transmit it to the driving command generator when a threshold value of SLAM quality of the positioning information is lower than a set SLAM real value.

4. The positioning correction system according to claim 2, wherein the driving controller is configured to receive quality threshold value information for the detection data from the unmanned mobile body manager, and to generate the position correction control signal and transmit it to the driving command generator only when the received quality threshold value information is lower than a set SLAM real value.

5. The positioning correction system according to claim 2, wherein, when transmitting the driving control signal for the position correction control signal to the unmanned mobile body manager, the driving command generator is configured to generate priority information for the driving control signal and transmit it together with the driving control signal.

6. The positioning correction system according to claim 1, wherein the unmanned mobile body manager comprises:
a data acquisitor for receiving the detection data detected by the distance detector and transmitting the received detection data to the driving manager;
a driving controller for correcting a position of the unmanned mobile body when the driving control signal is received from the driving manager; and
a schedule manager for comparing the work schedule information of the unmanned mobile body with the priority information of the driving control signal to generate driving priority list information for the unmanned mobile body, and sharing the driving priority list information with the driving controller.

7. The positioning correction system according to claim 6, wherein the data acquisitor is configured to periodically generate quality threshold value information for the detection data at predetermined time intervals and transmit the generated quality threshold value information to the driving manager.

8. The positioning correction system according to claim 6, wherein, when the driving control signal is received, the driving controller is configured to check an importance of task information for a task currently being performed by the unmanned mobile body, and, when a priority of the currently performed task is higher than a position correction task for the unmanned mobile body as a result of the check, to control the position correction to be performed after the currently performed task is completed.

9. The positioning correction system according to claim 1, wherein the distance detector is configured as a single-channel sensor module or a multi-channel sensor module comprising at least two or more sensors.

10. A positioning correction method using a positioning correction system for an unmanned mobile body, the method comprising steps of:
(a) acquiring, via a distance detector, detection data comprising distance information and image information between an unmanned mobile body and an object;
(b) generating, by a positioning and mapping part of a driving manager, positioning information and new map information of the unmanned mobile body based on Simultaneous Localization And Mapping (SLAM) on a basis of the detection data;
(c) analyzing, by a driving controller of the driving manager, the positioning information and new map information to generate a position correction control signal for the unmanned mobile body, and transmitting the generated position correction control signal to a driving command generator;
(d) generating, by the driving command generator that received the position correction control signal, a driving control signal for the unmanned mobile body and transmitting the driving control signal to a driving controller of an unmanned mobile body manager; and
(e) correcting a position of the unmanned mobile body according to a control of the driving controller;
wherein the step (e) comprises:
(e1) checking whether working devices are in operation;
(e2) if the working devices are in an operational state, checking task priority information for work schedule information generated by a schedule manager;
(e3) if the task priority information of the working devices is higher than priority information of the driving control signal, controlling currently performed task to continue, and if the task priority information is lower than the priority information of the driving control signal, interrupting the currently performed task; and
(e4) when the interruption of the task is completed, controlling a driving means to correct the position of the unmanned mobile body.

11-12. (canceled)

13. The method according to claim 10, further comprising, after the step (e):
(f) a data refining step of analyzing data stored in a database of the driving manager to identify a presence of abnormal data, and processing the abnormal data if it exists.
